(19) United States
(12) Patent Application Publication
(10) Pub. No.: US 2016/0046114 A1
(43) Pub. Date: Feb. 18, 2016

(54) WINDOW LAMINATED PACKAGE AND APPARATUS AND METHODS OF MAKING THE SAME

(71) Applicant: PaperWorks Industries, Inc., Philadelphia, PA (US)

(72) Inventor: Tim Woolvett, Denfield (CA)

(21) Appl. No.: 14/791,898

(22) Filed: Jul. 6, 2015

Related U.S. Application Data
(60) Provisional application No. 62/022,294, filed on Jul. 9, 2014.

(51) Int. Cl. B32B 38/00; B32B 27/08; B32B 27/36; B32B 3/26; B32B 27/32

(52) U.S. Cl. CPC B32B 38/0004; B32B 3/266; B32B 27/32; B32B 27/36; B32B 27/08; B32B 2307/7246; B32B 2439/70; B32B 2307/412

(57) ABSTRACT

A method for producing a product package having one or more laminated window portions includes supplying a web of packaging material to an inline process including one or more die cutting stages and a lamination stage, the web of packaging material having a lamination side and an opposing non-lamination side; cutting one or more window apertures into the web of packaging material; and laminating the lamination side of the web of packaging material to form the product package, the lamination side forming the exterior of the product package and the non-lamination side forming the interior of the product package.

### CROSS-REFERENCE TO RELATED APPLICATIONS

This application claims priority to U.S. Provisional application Ser. No. 62/022,294 entitled WINDOW LAMINATED PACKAGE AND APPARATUS AND METHODS OF MAKING SAME filed on Jul. 9, 2014, the contents of which are incorporated fully herein by reference.

### FIELD

This invention relates to printed articles such as product packages, processes for the manufacture of printed articles, and devices used to manufacture printed articles.

### SUMMARY

Aspects of the invention relate to product packages and printed articles, as well as devices and processes for producing product packages and/or printed articles.

In accordance with one aspect, the invention provides a method for producing a product package having one or more laminated window portions. The method includes the steps of supplying a web of packaging material to an inline process including one or more printing stages, one or more cutting stages, and a lamination stage, the web of packaging material having a lamination side and an opposing non-lamination side; printing one or more images on the lamination side of the web of packaging material; cutting one or more window apertures into the web of packaging material; and laminating the lamination side of the web of packaging material to form the product package, the lamination side forming the exterior of the product package and the non-lamination side forming the interior of the product package.

In accordance with another aspect, the invention provides a product packaging obtained according to any of the inventive methods. In one embodiment, the invention provides a product package. The product package includes a layer of packaging material having a lamination side, an opposing non-lamination side forming an interior of the product package, and one or more apertures. A layer of laminate is disposed on the lamination side of the layer of packaging material, the layer of laminate forming an exterior surface of the product package and covering the one or more apertures to form one or more viewable windows. A layer of ink is disposed between the layer of laminate and the layer of packaging material.

In accordance with yet another aspect, the invention provides an apparatus for producing a product package having one or more laminated window portions. The apparatus includes a plurality of inline stations which include one or more printing stations configured to print upon a lamination side of a web of packaging material; one or more die cutting stations configured to die cut one or more window apertures in the web of packaging material; and a lamination station configured to laminate a film to the lamination side of the web of packaging material.

In accordance with still another aspect, the invention provides a method of producing a printed article having one or more covered window portions. The method includes the steps of passing a blank through at least one printing station to print one or more images on a first side of the blank; passing the blank through at least one die cutting station that is inline with the at least one printing station; die cutting one or more window apertures in the blank at the at least one die cutting station; passing the blank through at least one lamination station that is inline with the at least one printing station and the at least one die cutting station; and applying a film over the first side of the blank at the at least one lamination station to cover the one or more window apertures and at least a portion of the first side of the blank with the film.

In accordance with still another aspect, the invention provides a printed article obtained according to any of the inventive methods.

In accordance with still another aspect, the invention provides an apparatus for producing a printed article having one or more covered window portions. The apparatus includes one or more printing stations operable to print one or more images on a material. One or more die cutting stations are inline with the one or more printing stations, and the one or more die cutting stations are operable to die cut one or more window apertures in the material. A lamination station is inline with the one or more printing stations and the one or more die cutting stations, and the lamination station is operable to laminate a film over the one or more images printed on the material.

In accordance with still another aspect, the invention provides a method for producing a product package having one or more laminated window portions. The method includes the steps of supplying a web of packaging material to an inline process including one or more cutting stages and a lamination stage, the web of packaging material having a lamination side and an opposing non-lamination side; cutting one or more window apertures into the web of packaging material; and laminating the lamination side of the web of packaging material to form the product package, the lamination side forming the exterior of the product package and the non-lamination side forming the interior of the product package.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1A is a schematic illustration of a product package according to aspects of the present invention;

FIG. 1B is a photograph of a product package according to aspects of the present invention

FIG. 2 is a flow diagram of a method for producing a product package having one or more laminated window portions according to aspects of the present invention;

FIG. 3 is a schematic illustration of an apparatus for producing a product package having one or more laminated window portions according to aspects of the present invention; and

FIG. 4 is a flow diagram of a method for producing a printed article having one or more covered window portions according to aspects of the present invention.

### DETAILED DESCRIPTION OF THE INVENTION

Aspects of the invention relate to product packages and printed articles, as well as devices and processes for producing product packages and/or printed articles.

The inventors have recognized that it would be useful to provide for an inline process and apparatus for the production of product packages for consumer goods such as foodstuffs, medical and pharmaceutical products, electronic products, and others. As used herein, an “inline” process is a process in which the web of packaging material may be continuously moved throughout the stages or stations of the inline process. In an inline process, the web of packaging material may pass through each stage or station without interruption (e.g., the web of packaging material may move directly from one or more die cutting stages to a lamination stage without stopping the inline process). It should be understood that an inline process does not require that the web of packaging material move continuously through the inline process, but only requires that the stages or stations of the inline process be configurable to continuously move the web of packaging material.

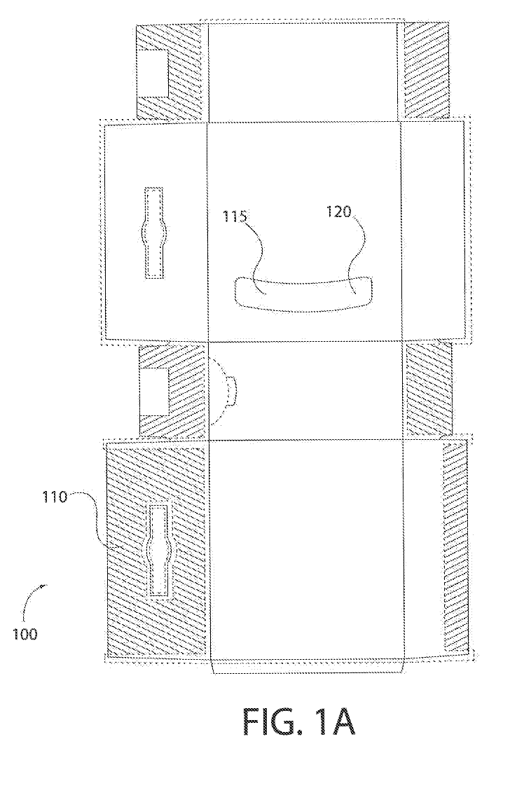

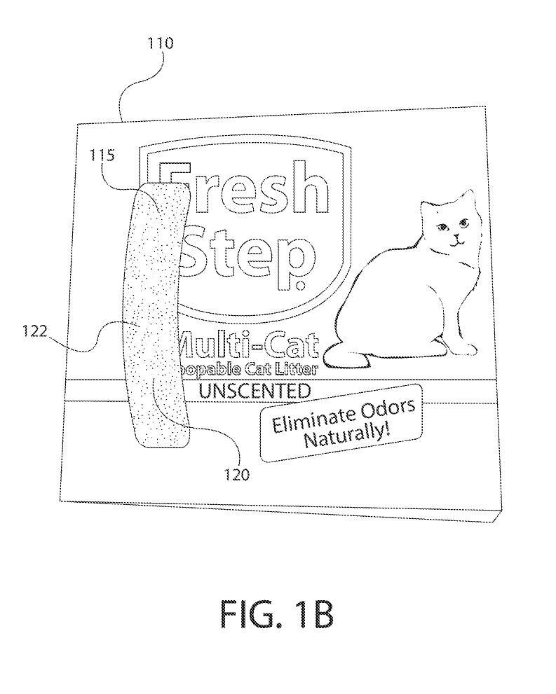

Turning to FIG. 1A, an unassembled product package 100 according to one aspect of the present invention is provided. Unassembled product package 100 is formed of a composite sheet material which includes an exterior surface 110. Exterior surface 110 is the surface of the product package which, upon assembly of the product package as shown by FIG. 1B, is presented to and viewable by, e.g., a consumer.

Turning back to FIG. 1A, exterior surface 110 is formed of a layer of laminate. The layer of laminate may be formed of a transparent plastic film material. Exemplary laminates include films of, e.g., polyethylene, polypropylene, polyester, and mixtures thereof. In one embodiment, the layer of laminate may be formed of a film of oriented poly-propylene (“oPP”) or polyethylene terephthalate.

The layer of laminate may be layered on top of a layer of ink printed on a lamination side of a layer of packaging material. In one embodiment, the layer of laminate is extruded onto or adhered to the lamination side of a layer of packaging material. The layer of laminate may be adhered via a layer of adhesive. Exemplary adhesives include pressure sensitive adhesives and energy curable adhesives.

The layer of ink may be deposited on the layer of packaging material through any known means including, e.g., one or more stages of flexographic printing.

The layer of packaging material also includes a non-lamination side which forms the interior of product package 100. The layer of packaging material may be formed of a non-transparent material such as paper, metalized polymer film, aluminum foil, or boxboard.

Unassembled product package 100 includes an aperture 115 which may be cut from the layer of packaging material. Preferably, aperture 115 is cut from the layer of packaging material prior to the application of the layer of laminate, as is more fully described below with respect to the inventive processes.

While one of ordinary skill will understand that the layer of laminate may extend across less than all of exterior surface 110, the layer of laminate desirably extends completely across aperture 115 to form viewable window 120. Viewable window 120 provides, e.g., a consumer with the ability to view the contents of product package 100 once assembled through the layer of laminate, which can be transparent. Turning briefly to FIG. 1B, viewable window 120 permits an end user to visually inspect the contents of product package 100 and, e.g., determine the amount of remaining product 122. The amount of remaining product 122, here cat litter, is viewable through viewable window 120. A product housed in product packaging 100 thus has additional shelf appeal and generates increased consumer interest over other product packaging.

The inventors have also found that, by providing the layer of laminate on the exterior surface of the product packaging, an enhanced moisture vapor transmission rate (“MVTR”) may be achieved. That is, the exterior layer of laminate reduces the amount of moisture transmitted to the interior of product packaging (where the product resides) as compared to product packaging having a film adhered to the interior of the product packaging. Moisture sensitive products, such as moisture sensitive foods, packaged in the inventive product packaging thus achieve enhanced quality, safety, and shelf life.

The shape of viewable window 120 is depicted as a crescent in FIGS. 1a and 1b for illustrative purposes. One of ordinary skill in the art will understand that viewable window 120 may take any known two-dimensional regular or irregular shape such as, without limitation, a circle, rectangle, square, polygon, etc. The shape of viewable window 120 may be controlled by the shape of the aperture cut out of the layer of packaging material.

One of ordinary skill in the art will further understand that, while a single viewable window 120 is depicted in FIGS. 1a and 1b, the invention is not so limited. Indeed, a plurality of viewable windows may be located on a single product packaging according to the present invention.

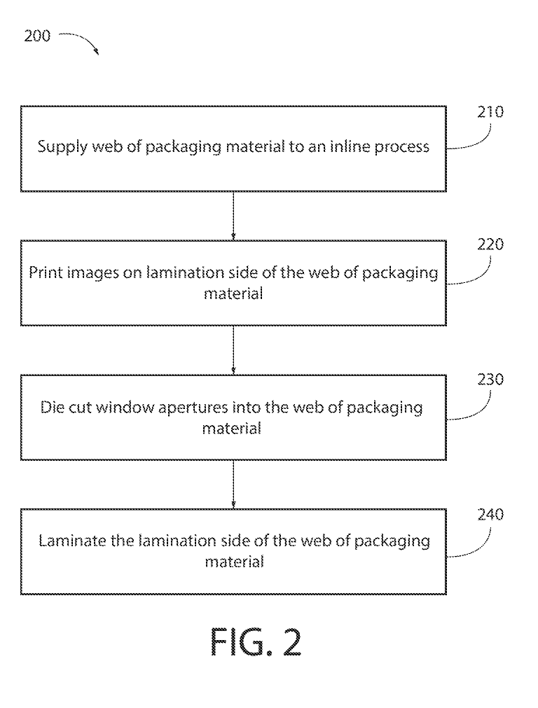

Turning to FIG. 2, a flow diagram depicting selected steps of a process 200 for producing a product package having one or more laminated window portions according to aspects of the invention is shown. It should be noted that, with respect to the methods described herein, it will be understood from the description herein that one or more steps may be omitted and/or performed out of the described sequence of the method (including simultaneously) while still achieving the desired result. In addition, it will be understood that other steps, not described herein but known to persons skilled in the art, can be performed in processes according to the invention, while still achieving the desired result.

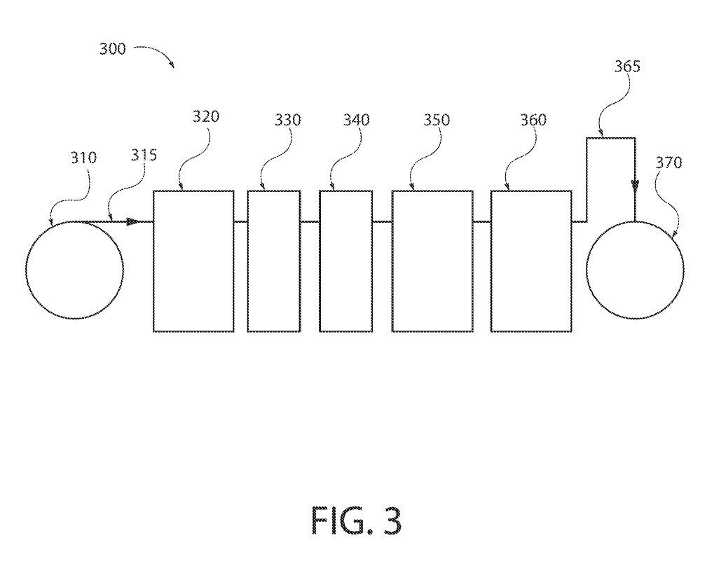

Certain elements of process 200 are illustrated in FIG. 3, which depicts a schematic of an apparatus for producing a product package having one or more laminated window portions. For clarity of understanding, and without any intention of limiting process 200 to the apparatus shown in FIG. 3, process 200 will be described below with respect to the apparatus of FIG. 3.

In step 210, a web of packaging material 315 is supplied from an unwind roller 310 to an inline process 300. Inline process 300 may include one or more printing stages 320, one or more die cutting stages 340, and one or more lamination stages 360. The inline process may be a single apparatus or may be multiple apparatuses configured to continuously move web of packaging material 315. The inventors have found that the use of an inline process desirably reduces production time, especially where, as with inline processes, processing of the web of packaging material does not need to stop to physically transfer the web of packaging material from one stage to the next.

Web of packaging material 315 is a web or sheet-shaped material in the form of long sheets or rolls which are subsequently shaped into containers and filled. Web of packaging material 315 forms at least one layer of a product package and may be comprised of, e.g., a non-transparent material such as paper, metalized polymer film, or aluminum foil. Web of packaging material 315 typically includes a lamination side and an opposing non-lamination side.

In step 220, one or more images or indicia are printed on the lamination side of web of packaging material 315. The images may be deposited on web of packaging material 315 through one or more printing stages 320 which employ any known means for printing images onto webs of packaging materials including, e.g., one or more stages of flexographic printing. One of ordinary skill in the art will understand that several stages of flexographic printing may be desirable for a given web of packaging material. In one embodiment, the inline process includes seven or more flexographic printing stages.

After one or more printing stages, the location of apertures to be cut into web of packaging materials may be registered by registry 330. Synchronization marks resulting from the one or more printing stages may be detected by an optical sensor, which identifies a location or locations of one or more apertures to be cut. Synchronization marks may also be used at a later stage for cutting composite packaging material to form the unit product packages.

In step 230, one or more window apertures are cut into web of packaging material 315. Die cutting may be performed at one or more die cutting stages 340. As described above, the shape of the viewable window on the resulting product packaging corresponds to the shape of the aperture cut out of the layer of packaging material. Die cutting stage 340 may be configured with a die cutting tool associated with the desired shape of aperture. Thus, a variety of aperture (and the associated viewable window) shapes may be achieved as described above. Further, one of ordinary skill in the art will understand that, in addition to die cutting, other cutting means such as laser cutting or water jet cutting may be employed.

Die cutting stage 340 may also include the removal of the resulting excess packaging material. Removal may occur through any means known to one of ordinary skill in the art, including a vacuum/pressure roll over which retains the excess packaging material on the roll surface after the die cut packaging material passes off the roll. Alternatively, a rotary pin mechanism can be used to remove excess packaging material.

In step 240, the lamination side of the web of packaging material is laminated to form the product package, such that the lamination side forms the exterior of the product package and the non-lamination side forms the interior of the product package. Depending on the number of apertures per product package, each resulting product package may have one, two, or more laminated window portions. Lamination may be performed at one or more lamination stages 360. Step 240 may include applying a web of film material as a laminate. Suitable laminates include, e.g., polyethylene, polypropylene, polyester, and mixtures thereof. In one embodiment, the laminate may be formed of a film of oriented poly-propylene (“oPP”) or polyethylene terephthalate.

The web of film material may be adhered to the lamination side of the web of packaging material 315 through a coating of adhesive. The coating of adhesive may be applied to either the web of film material or the lamination side of the web of packaging material 315. Exemplary adhesives include pressure sensitive adhesives. In one embodiment, the layer of laminate is extruded onto or adhered to the lamination side of the web of packaging material 315.

The web of film material may be joined to web of packaging material 315 through a nip roller (not shown) to produce a web of composite packaging material 365.

The web of composite packaging material 365 exiting the one or more lamination stages 360 is then advanced to rewind roller 370 and spooled for subsequent use.

In accordance with another aspect, the invention provides a product packaging obtained according to any of the inventive methods.

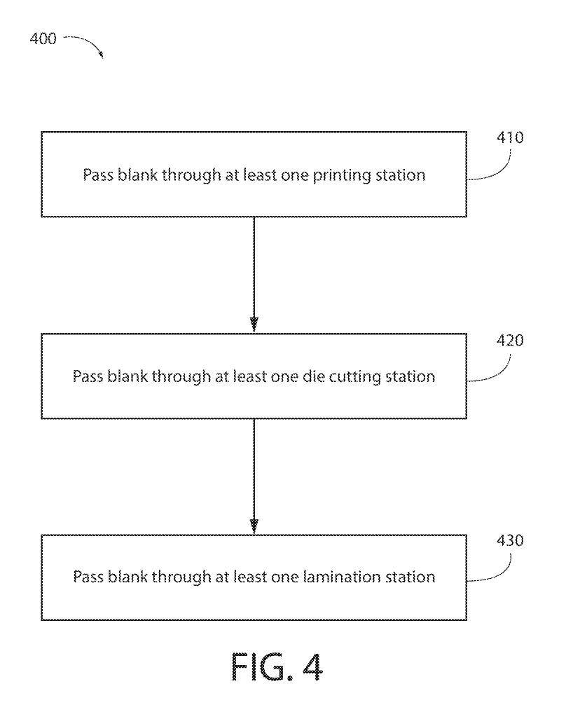

Turning to FIG. 4, a flow diagram depicting selected steps of a process 400 for producing a printed article having one or more covered window portions in accordance with the present invention is depicted. In one embodiment, the printed article is a product package.

In step 410, a blank is passed through at least one printing station to print one or more images or indicia on a first side of the blank. The blank may be a web or sheet-shaped material in the form of long sheets or rolls which are subsequently shaped into containers and filled. The blank may be comprised of packaging material which forms at least one layer of a product package. The printed images or indicia can include synchronization marks, as described earlier, for subsequently identifying the location of apertures to be cut in the next stage.

In step 420, the blank is passed through at least one die cutting station that is in line with the at least one printing station. At the die cutting station, one or more window apertures are die cut in the blank.

In step 430, the blank is passed through at least one lamination station that is inline with the at least one printing station and the at least one die cutting station. At the lamination station, a film is applied over the first side of the blank to cover the one or more window apertures and at least a portion of the first side of the blank. In one embodiment, the film extends across the one or more apertures. The film may be a clear transparent film. In one embodiment, the step of applying a film includes applying a moisture barrier over the one or more window apertures.

The film may be adhered to the first side of the blank through a coating of adhesive. The coating of adhesive may be applied to either the film or the first side of the blank. The coating of adhesive may occur after the step of die cutting one or more window apertures in the blank.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for producing a product package having one or more laminated window portions comprising the steps of:
supplying a web of packaging material to an inline process including one or more die cutting stages and a lamination stage, the web of packaging material having a lamination side and an opposing non-lamination side;
cutting one or more window apertures into the web of packaging material; and
laminating the lamination side of the web of packaging material to form the product package, the lamination side forming the exterior of the product package and the non-lamination side forming the interior of the product package.

2. The method of claim 1 further comprising, prior to the laminating step, printing one or more images on the lamination side of the web of packaging material.

3. The method of claim 1 further comprising, prior to the laminating step, coating an adhesive on the lamination side of the web of packaging material.

4. The method of claim 1 further comprising, prior to the cutting step, registering one or more locations for die cutting in the web of packaging material.

5. The method of claim 1 further comprising removing excess packaging material resulting from the die cutting step.

6. The method of claim 1, wherein the laminating step comprises the step of applying a web of film material selected from a group consisting of oriented poly-propylene and polyethylene terephthalate.

7. The method of claim 5, wherein the web of film material is oriented polypropylene.

8. The method of claim 2, wherein the inline process comprises seven or more flexographic printing stages.

9. The method of claim 1, wherein the inline process is housed within a single apparatus.

10. The method of claim 1, wherein the product package has two or more laminated window portions.

11. A product package produced according to the method of claim 1.

12. A product package comprising:
a layer of packaging material having a lamination side, an opposing non-lamination side forming an interior of the product package, and one or more apertures;
a layer of laminate disposed on the lamination side of the layer of packaging material, the layer of laminate forming an exterior surface of the product package and covering the one or more apertures to form one or more windows through which a product in the interior of the product package can be viewed; and
a printed layer disposed between the layer of laminate and the layer of packaging material.

13. The product package of claim 12, wherein the layer of laminate is selected from the group consisting of oriented poly-propylene and polyethylene terephthalate.

14. The product package of claim 12, further comprising a layer of adhesive between the layer of packaging material and the layer of laminate.

15. An apparatus for producing a product package having one or more laminated window portions, the apparatus comprising a plurality of inline stations, the inline stations including:
one or more printing stations configured to print upon a lamination side of a web of packaging material;
one or more die cutting stations configured to die cut one or more window apertures in the web of packaging material; and
a lamination station configured to laminate a film to the lamination side of the web of packaging material.

16. The apparatus of claim 15, wherein the plurality of inline stations further comprises a coating station configured to coat an adhesive on the lamination side of the web of packaging material to secure the film to the web of packaging material.

17. The apparatus of claim 15, wherein the plurality of inline stations further comprises a removal station configured to remove excess packaging material from the die cutting station.

18. The apparatus of claim 15, wherein the plurality of inline stations further comprises a registry station configured to register locations of the window apertures to be die cut.

19. The apparatus of claim 15, wherein the one or more flexographic printing stations comprises at least seven flexographic printing stations.

20. The apparatus of claim 15, further comprising a first input for the web of packaging material and a second input for a web of laminate film.
